(19) United States
(12) Patent Application Publication
(10) Pub. No.: US 2016/0371250 A1
(43) Pub. Date: Dec. 22, 2016

(54) TEXT SUGGESTION USING A PREDICTIVE GRAMMAR MODEL

(71) Applicant: MICROSOFT TECHNOLOGY LICENSING, LLC, REDMIND, WA (US)

(72) Inventor: ALEXANDER CHRISTAN RHODES, BELLEVUE, WA (US)

(21) Appl. No.: 14/740,999

(22) Filed: Jun. 16, 2015

(51) Int. Cl. G06F 17/27; G06F 3/0488

(52) U.S. Cl. CPC G06F 17/276; G06F 3/04886

(57) ABSTRACT

The technology described herein can improve the operation of a computerized text entry system (e.g., keyboard, speech to text) by making grammatically correct auto-complete suggestions as a user enters text. The technology described herein builds and uses a set of generalized rules that make the auto-complete feature sensitive to the context of what has already been typed, particularly at the level of a sentence or phrase. The technology described herein receives one or more words within a partially completed sentence and outputs one or more contrastive grammatical categories that the next word may be if the final sentence is to be grammatical.

### BACKGROUND

Various applications currently help users complete text entry by suggesting words that are consistent with text already entered by the user. For example, the words “December,” “decibel,” or “decried” may be suggested in response to a user typing “dec.” A common methodology generates suggestions on the frequency of word occurrence within an active language. Essentially, available technology can flip through a dictionary of available words and suggest the most commonly occurring words within the dictionary that match the already entered text. Most interfaces have limited space for suggestions and the word the user is actually typing is often not in the suggestions provided. The current methods may not consider whether suggested words make grammatical sense in the available context.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The technology described herein can improve the operation of a computerized text entry system (e.g., keyboard, speech to text) by making grammatically correct auto-complete suggestions as a user enters text. The auto-complete technology suggests words and/or phrases that are consistent with present grammatical context. The auto-complete words may also be consistent with one or more characters entered for the next word in a sentence or phrase. The technology described herein provides a more accurate auto-complete suggestion which reduces the number of key presses a computing device needs to process because the user is more likely to find, and therefore select, the word being entered from an auto-complete list. Less key presses means increasing the efficiency of the text input system.

The technology described herein builds and uses a set of generalized rules that make the auto-complete feature sensitive to the context of what has already been typed, particularly at the level of a sentence or phrase. The technology described herein receives one or more words within a partially completed sentence and outputs one or more contrastive grammatical categories that the next word may be if the final sentence is to be grammatical. For example, the next word could be a singular noun, singular pronoun, or an adjective.

Several different contrastive grammatical categories could form a grammatical sentence but different categories can be more likely than others. The technology described herein can also express a likelihood that the next word is within a particular contrastive grammatical category according to the most common grammatical usage. For example, if in most cases the next word in the sentence would be a noun, but a clever writer could form a grammatical sentence when the next word is a verb, then a noun would be described as a more likely usage for the next word. At this point, the actual noun or verb to be inserted is not considered, only its grammatical classification into one or more contrastive grammatical categories.

### BRIEF DESCRIPTION OF THE DRAWINGS

Aspects of the invention are described in detail below with reference to the attached drawing figures, wherein:

FIG. 1 is a block diagram of an exemplary computing environment suitable for implementing aspects of the technology described herein;

FIG. 2 is a diagram depicting a distributed computing environment for generating auto-complete words, in accordance with an aspect of the technology described herein;

FIG. 3 is a diagram depicting an auto-complete interface according to an aspect of the technology described herein;

FIG. 4 is a diagram depicting a distributed computing environment for training a generative grammar model, in accordance with an aspect of the technology described herein;

FIG. 5 is a table showing contrastive grammatical categories and example words in each category, in accordance with an aspect of the technology described herein;

FIG. 6 is a diagram illustrating a completion transformation, in accordance with an aspect of the technology described herein;

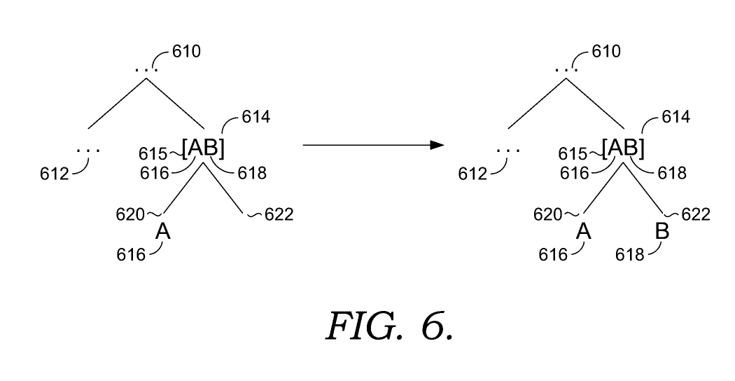

FIG. 7 is a diagram illustrating a leftward path expansion, in accordance with an aspect of the technology described herein;

FIG. 8 is a diagram illustrating a mutation transformation, in accordance with an aspect of the technology described herein;

FIG. 9 is a diagram illustrating a baking transformation at a first point, in accordance with an aspect of the technology described herein;

FIG. 10 is a diagram illustrating a baking transformation at a second point, in accordance with an aspect of the technology described herein;

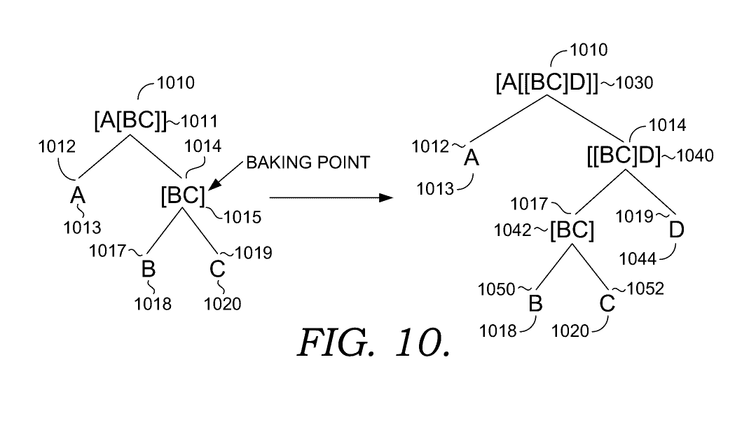

FIG. 11 is a flow chart depicting a method that generates an auto-complete word, in accordance with an aspect of the technology described herein; and

FIG. 12 is a flow chart depicting a method of suggesting a grammatically correct auto-complete word to a user, in accordance with of the technology described herein.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein can improve the operation of a computerized text entry system (e.g., keyboard, speech to text) by making grammatically correct auto-complete suggestions as a user enters text. The auto-complete technology suggests words and/or phrases that are consistent with present grammatical context. The auto-complete words may also be consistent with one or more characters entered for the next word in a sentence or phrase. The technology described herein provides a more accurate auto-complete suggestion which reduces the number of key presses a computing device needs to process because the user is more likely to find, and therefore select, the word being entered from an auto-complete list. Less key presses means increasing the efficiency of the text input system.

The technology described herein builds and uses a set of generalized rules that make the auto-complete feature sensitive to the context of what has already been typed, particularly at the level of a sentence or phrase. The technology described herein receives one or more words within a partially completed sentence and outputs one or more contrastive grammatical categories that the next word may be if the final sentence is to be grammatical. For example, the next word could be a singular noun, singular pronoun, or an adjective. Each of the contrastive grammatical categories could form a grammatical sentence but different categories can be more likely than others. The technology described herein can also express a likelihood that the next word is within a particular contrastive grammatical category according to the most common grammatical usage. For example, if in most cases the next word in the sentence would be a noun, but a clever writer could form a grammatical sentence when the next word is a verb, then a noun would be described as a more likely usage for the next word. At this point, the actual noun or verb to be inserted is not considered, only its grammatical classification into one or more contrastive grammatical categories.

The technology described herein can work with other language models to generate auto-complete suggestions. In one aspect, a probabilistic language model generates a plurality of auto-complete words. The probabilistic language model may use a natural learning mechanism that uses word frequency and word combinations to generate preliminary auto-complete suggestions. The probabilistic language model may be trained using grammatical text which causes many of the probabilistic language model's preliminary suggestions to be grammatical. However, the probabilistic language model may not be constrained by grammatical rules and weighs many different factors that can cause ungrammatical words to be suggested through auto-complete. For example, very common words in a language may be suggested even though the word would be ungrammatical in the current context.

The output from the generative grammar model can be used to eliminate preliminary auto-complete suggestions that are not classified into one or more of the contrastive grammatical categories that would make a partially completed sentence grammatical if the next word in the sentence is in one or more of the contrastive grammatical categories. The output from the generative grammar model can also be used to reorder the preliminary auto-complete suggestions to increase a ranking of words assigned to a contrastive grammatical category with a relatively higher likelihood of usage.

The reordered auto-complete words can then be output through an auto-complete interface that allows a user to select one of the words instead of continuing typing the word. The auto-complete interface inserts the selected word into the document being composed. The document could be a text message, an email message, a word processing document, a webpage, or such.

Aspects of the present technology can use phrase structure rules and generative syntax to build a grammar model. The “generative” in generative syntax refers to the notion that sentence structures can be generated from phrase structure rules (PSRs). A phrase structure rule has the form: X→AB. The phrase structure rule can correspond to a binary branching structure (the parent node X has the children A and B). In other words, the phrase X includes the constituents A and B.

The words in the sentence, “Mary jumped off the bench,” can be classified into the following parts of speech: Mary (N) jumped (V) off (P) the (D) bench (N), where N=noun, V=verb, P=preposition, and D=determiner Each word is a constituent. Phrase structures can be generated by combining constituents. For example, the sentence includes a determiner phrase (DP) comprising “the bench,” a prepositional phrase (PP) “off the bench,” a verb (V′) phrase “jumped off the bench,” and the sentence (S) “Mary jumped off the bench.” The same constituents can be expressed as a series of phrase structure rules: DP→D N, PP→P DP, V′→V PP, and S→N V′. By treating constituency as a sliding scale, a sentence can be turned into a binary tree by iteratively partitioning it into the sub-phrases that exhibit the strongest constituency.

Changing the sentence to include an adverb, as in “Mary jumped off the bench gracefully,” introduces an additional definition for a verb phrase V′→V′ Adv.

The technology described herein can attach a cost to each PSR. The costs are calculated by determining which PSRs are likely to result in ungrammatical phrases, and give them higher costs. In this way, the technology can estimate which sentences are less grammatical by seeing which sentences are more expensive to convert into tree structures using the PSRs. The model can be used to measure the grammaticality of continuing the current sentence with each of the candidate PSRs, and demote the candidates that result in the least grammatical sentences.

The technology described herein can be deployed in three discrete processes that comprise training, searching, and scoring. The training process involves building a grammatical model of a language to generate a plurality of PSRs. Searching involves looking for a PSR(s) within the grammatical model that conforms to the grammatical context in which a new word is being entered. The scoring process assigns a grammatical cost to various PSRs identified in the search process. The PSR(s) with the lowest grammatical cost can then be used to identify a grammatically correct auto-complete word(s).

### DEFINITIONS

Having briefly described an overview of aspects of the invention, a few frequently used terms are explicitly defined to orient the reader. Terms not included within the Definitions Section may be defined elsewhere, including by example.

Grammar: In natural language, grammar is a set of rules restricting which kinds of words can appear in which places within a sentence, phrase, or other language unit. Almost all theoretical grammar models describe sentences as having tree structures.

Constituency: “Constituency” refers to the ability of a phrase to function as a single unit. Phrases which exhibit constituency are the “constituents” of a sentence. “Mary fell off the bench” has the non-trivial constituents: “the bench,” “off the bench,” “fell off the bench”. (Each word, and the entire sentence, are also constituents.)

Generative Grammar Model: “Generative” refers to the notion that sentence structures can be generated from phrase structure rules (PSRs). The generative grammar model produces a binary decision about correct grammar. A binary yes/no decision is in contrast to a probabilistic model that determines a probability that a given usage is grammatical.

Phrase structure rule: A phrase structure rule has the form: X→AB. Aspects of the technology described herein can use phrase structure rules and generative syntax to build a grammar model. The “generative” in generative syntax refers to the notion that sentence structures can be generated from phrase structure rules (PSRs). A phrase structure rule has the form: X→AB. The phrase structure rule can correspond to a binary branching structure (the parent node X has the children A and B). In other words, the phrase X includes the constituents A and B.

Node: is an element in a hierarchical tree.

Root: is a special kind of node with no superior node.

Leaf: is a special kind of node without branches. At least, they may also be described as an end node.

Branch: is a line connecting nodes within a hierarchical tree.

Parent: is a node one step higher in the hierarchy and connected by a branch to a child node.

Sibling: is a node that shares the same parent node.

Having briefly described an overview of aspects of the invention, an exemplary operating environment suitable for use in implementing aspects of the invention is described below.

### Exemplary Operating Environment

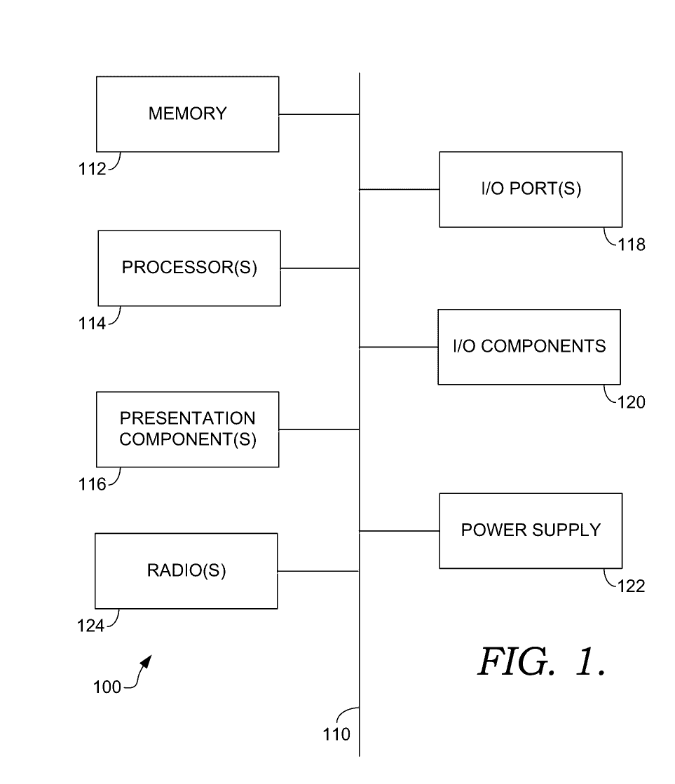

Referring to the drawings in general, and initially to FIG. 1 in particular, an exemplary operating environment for implementing aspects of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the invention may be practiced in a variety of system configurations, including handheld devices, consumer electronics, general-purpose computers, specialty computing devices, etc. Aspects of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more aspects of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 112 includes computer storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112, or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In embodiments, a pen digitizer (not shown) and accompanying input instrument (also not shown but which may include, by way of example only, a pen or a stylus) are provided in order to digitally capture freehand user input. The connection between the pen digitizer and processor(s) 114 may be direct or via a coupling utilizing a serial port, parallel port, and/or other interface and/or system bus known in the art. Furthermore, the digitizer input component may be a component separate from an output component such as a display device, or in some embodiments, the usable input area of a digitizer may be co-extensive with the display area of a display device, integrated with the display device, or may exist as a separate device overlaying or otherwise appended to a display device. Any and all such variations, and any combination thereof, are contemplated to be within the scope of embodiments of the present invention.

An NUI processes air gestures, voice, or other physiological inputs generated by a user. Appropriate NUI inputs may be interpreted as ink strokes for presentation in association with the computing device 100. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

A computing device may include a radio. The radio transmits and receives radio communications. The computing device may be a wireless terminal adapted to receive communications and media over various wireless networks. Computing device 100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

### Computing Environment

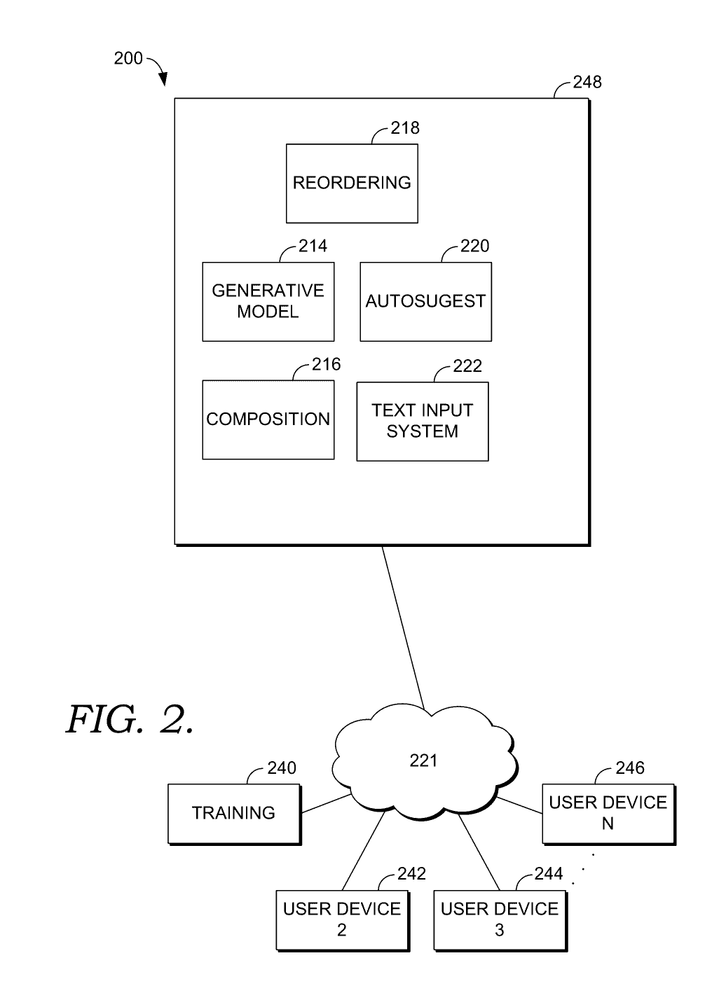

Turning now to FIG. 2, a computing environment 200 suitable for generating auto-complete suggestions is provided, in accordance with an aspect of the technology described herein. The computing environment 200 includes user device 1 248, network 221, training component 240, user device 2 242, user device 3 244, and user device N 246. The user device 1 248 includes the generative model 214, the composition component 216, the reordering component 218, the autosuggest component 220, and a text input system 222. Other components are not shown for the sake of simplicity. In one aspect, the user devices communicate queries over the network 221 with the training component 240 to receive updated language models. The user devices may be personal computers, tablets, smartphones, or other computing devices. The user devices may have components similar to those described with reference to computing device 100. Each user device may have components similar to those shown for user device 1 248.

The generative model component 214 searches a generative grammar model for contrastive grammatical categories for which the next word in a sentence can be. The generative model component 214 can attach a cost to each PSR. The costs are calculated by determining which PSRs are likely to result in ungrammatical phrases, and give them higher costs. In this way, the generative model component 214 can estimate which sentences are less grammatical by seeing which sentences are more expensive to convert into tree structures using the PSRs. The model can be used to measure the grammaticality of continuing the current sentence with each of the candidate PSRs, and demote the candidates that result in the least grammatical sentences. The generative model component 214 can collapse an entire sentence into a single PSR. The entire sentence can comprise ten words, twenty words, or more.

### Searching

The PSRs define a search space (the set of all valid sentence structures), which we then navigate in order to assign a tree structure (and thus a cost) to a given sentence. The navigation can be performed using priority queues and A* searches. A priority queue is a container data structure which allows elements to be efficiently retrieved one by one in order of “priority”—a value set when elements are added—regardless of the actual order in which elements were added. An A* search of a graph uses a cost function to assign a priority to each path—the less costly a path, the higher the priority. The cheapest paths get explored first. It will always find the cheapest path to the goal node so long as the cost function is monotonically non-decreasing with regard to the length of a given path. The A* search is essentially a breadth-first search which has been optimized by replacing the queue with a priority queue.

PSRs, as they were described above, imply a top-down approach to sentence tree construction: every sentence begins as the “S” tag, and every possible sentence tree can be reached just by making different choices as to which PSRs are applied while expanding it. Put another way, the PSRs form a directed graph leading away from the S node, with each path through the graph corresponding to a different sentence tree.

In one aspect, a breadth-first approach is used to determine the lowest cost solution. In a breath-first approach, all of the possible trees corresponding to a particular sentence string are generated, and the lowest cost solution is returned, for example, using the A* search. The breath-first approach is computationally intensive, especially when the partial sentence is grammatically incorrect. When given an invalid sentence, the search queue would often hit millions of possible sentence trees before the algorithm confirmed that there was no way to decompose the sentence.

In another aspect, a bottom-up, depth-first approach is used to generate suitable contrastive grammatical categories and associated costs. The bottom-up, depth-first approach assumes that the partial sentence input forms a valid tree structure. The bottom-up, depth-first approach evaluates different ways to add a new word to the right-hand side of the valid tree structure and still produce another valid tree. In one aspect, each available contrastive grammatical category is tested to determine whether a valid tree structure can be produced and the associated cost of producing a valid tree structure.

The tree can be built up incrementally, word-by-word, or by choosing the least expensive tree candidate each time a word is added (i.e., a greedy approach). In one aspect, the greedy approach can be implemented as a modified A* search, with the cost function: cost=original cost×greediness^{-depth}. Following a path which causes the cost to increase by a factor of more than greediness forces the previous choice of paths to be reconsidered. The above violates the monotonically non-decreasing condition of the cost function, so the search is no longer guaranteed to find the lowest cost path. Adjusting greediness of 1.0 is identical to A*; greediness of ∞ is a true depth-first search. In one aspect, the greediness is set between 1.5 and 5, for example 2.0 or 3.0.

The search depends on three types of transformations, which can be used to add a word to the right-hand side of a sentence tree, called Completion, Mutation, and Baking, plus a special transformation called Cheating. The Baking transformation has the side effect of “baking” all of the useful information from one branch of the tree into a single node (allowing for some memory to be freed). As will be explained below, the combination of Baking and Cheating allows this algorithm to dynamically scale the context to the maximum amount that could be useful for making predictions—at times it will consider only the last word, at other times it will consider every word back to the beginning of the sentence. This provides almost perfect robustness. “Robustness” refers to the capability of a rule set to generate the set of all grammatical sentences, not only sentences with the same structure as those in the training data.

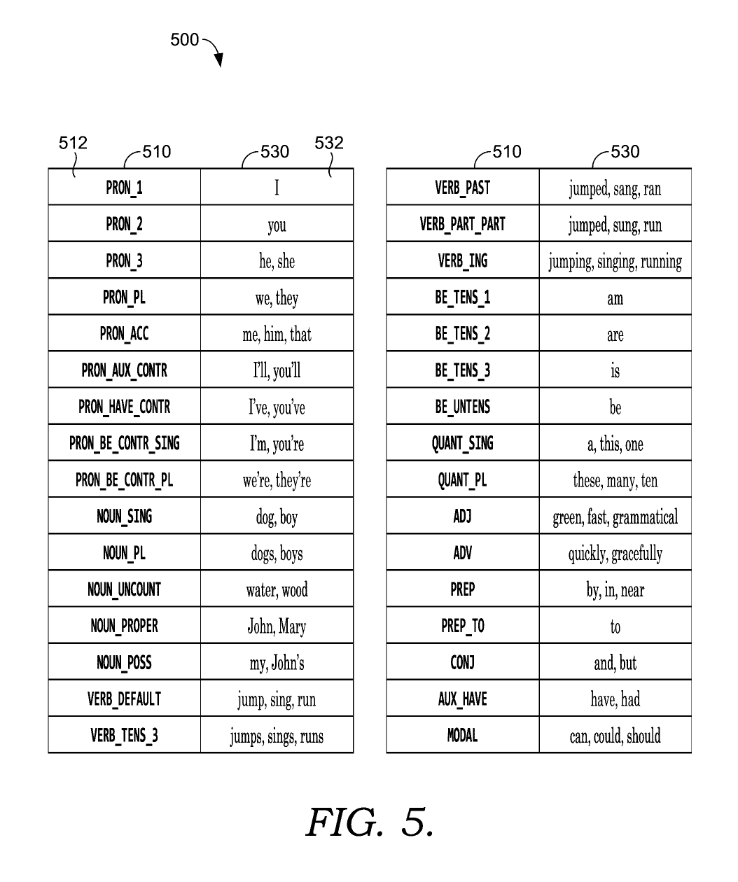

Completion is the simplest transformation, and takes place when we attempt to insert a leaf node, which is expected as the right branch of the rightmost rule in the current tree. A completion operation is illustrated in FIG. 5. Prior to completion, the hierarchical tree includes root node 610, left child node 612, and right child node 614. Each node is associated with a phrase structure rule or a single contrastive grammatical category. The categories are PSRs that are not specified for root node 610 or left child node 612. Right child node 614 is associated with PSR [AB] 615. PSR AB 615 includes the contrastive grammatical category A 616 and the contrastive grammatical category B 618. The PSR AB 615 has been expanded to leaf node 620 which is associated with contrastive grammatical category A 616. Prior to the completion, the right leaf node 622 is not associated with a contrastive grammatical category. The completion operation indicated by the arrow completes the expansion of the PSR AB 615 to associate the right leaf node 622 with the contrastive grammatical category B 618.

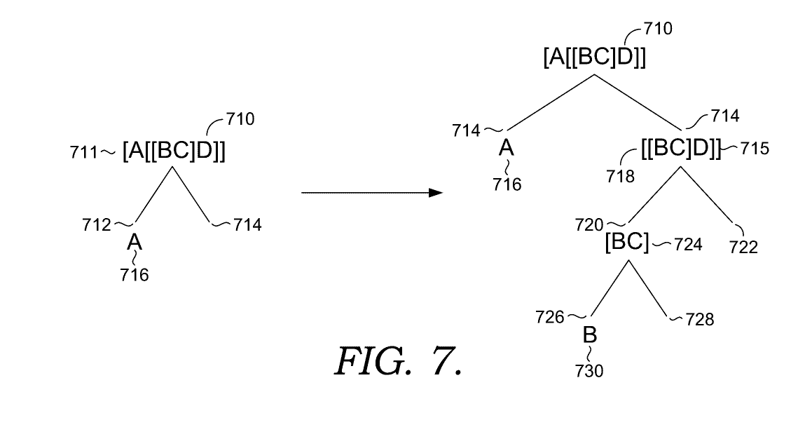

Leftward Path Expansion: The above description of Completion is an oversimplification, since sometimes the technology described herein needs to expand some non-leaf nodes before the next leaf can be inserted. Leftward Path expansion is common to all transformations. A more complicated case of completion is illustrated with reference to FIG. 7. Prior to completion and leftward expansion, the hierarchical tree includes root node 710, left leaf 712, and right leaf 714. The left leaf node 712 is associated with the contrastive grammatical category A 716. The right leaf node 714 is not associated with a contrastive grammatical category. The PSR [A[[BC]D] 711 at root node 710 is expanded to right child node 714, which is now associated with PSR [[BC]D] 715. PSR [[BC]D] 715 is further expanded to left child node 720, which is now associated with PSR [BC] 724. Right child node 722 is not associated with a contrastive grammatical category. A further expansion results in leaf node 726 being associated with contrastive grammatical category B 730. Leaf node 728 is not associated with a contrastive grammatical category.

If there are multiple ways to expand the top node while allowing us to insert the desired leaf, the technology described herein always chooses the expansion which adds the least to the height of the tree. This is because the Baking transformation allows intermediate branches to be inserted, but there is no transformation which allows for intermediate branches to be removed. Therefore, all of the possible expansion rules are reachable from the shortest expansion, but starting with a “longer” expansion rule would make the “shorter” rules unreachable.

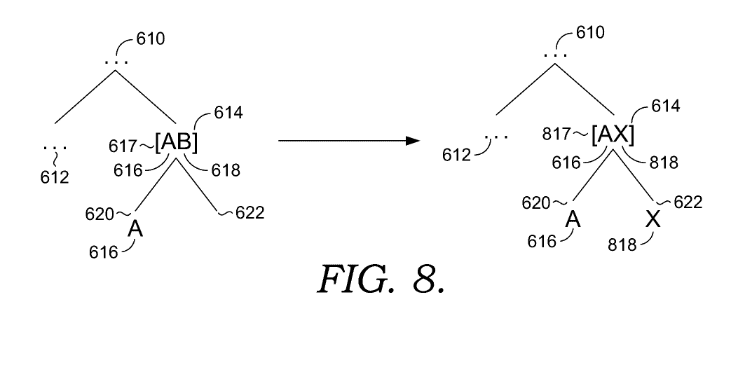

Transformations: Mutation. Mutation is like Completion, but it takes place when the current rule cannot accommodate the leaf node being inserted, but another rule exists which could. Completion is not simply a special case of Mutation, since Mutation is subject to validation (explained below) and Completion is not. FIG. 8 illustrates a mutation. The unmutated hierarchical tree includes root 610, leaf 612, and child node 614, which is associated with PSR [AB] 617. In this case, the contrastive grammatical category B 618 does not form a valid sentence structure within the model. Accordingly, a mutation is performed to swap B 618 with X 818. As X 818 forms a valid sentence structure, the leaf node 622 can be completed by association with X 818. Thus, the mutation changes the phrase structure rule [AB] 617 to PSR [AX] 817.

Transformations: Baking. The Baking transformation applies when the rightmost rule has no unfilled slots into which a leaf node could be inserted. It works by inserting a new rule to accommodate the insertion of the desired leaf node, thus increasing the height of the tree. Baking is so-called because it guarantees that the nodes on the left branch of the new rule will never be accessed again—any useful information they contained is now contained (“baked into”) the node representing the new rule.

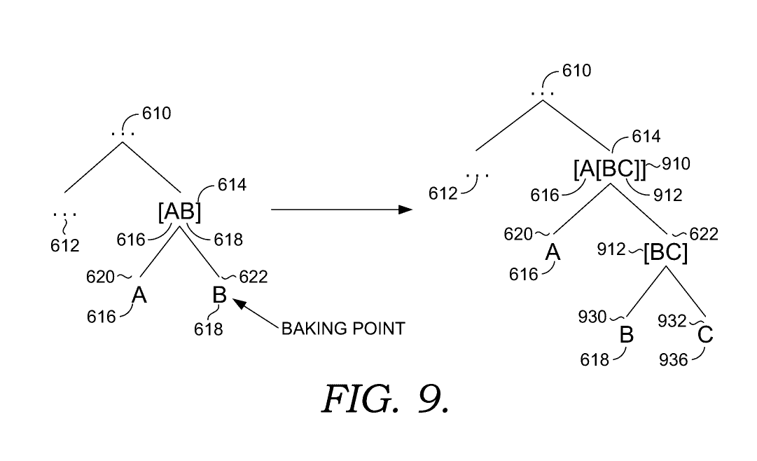

In FIG. 9, the contrastive grammatical category B 618 associated with leaf node 622 is baked into associate leaf node 622 with the PSR [BC] 912. Notice that this baking operation also causes the PSR associated with node 614 to be replaced. After the baking transformation, node 614 is associated with the PSR [A[BC]] 910. The baking operation allows for further expansion of the tree to leaf node 930 and leaf node 932. Leaf node 930 is associated with the contrastive grammatical category B 618, and leaf node 932 is associated with the contrastive grammatical category C 936.

There are multiple valid “baking points” where this operation can be applied, each of which yields a unique tree. Aspects of the technology described herein can attempt to apply the transformation at each of these points.

Validation and “Cheating.” Mutation and Baking require validation, since they modify an existing rule, and every node above that rule depends on it. If it is possible to modify each parent node of the changed rule in order to accommodate the change, we do so, and the change is “valid.” The problem is that the number of validation steps increases the larger the sentence tree gets, and this increases the probability that we will reject a valid tree because of a gap in the generative grammar model. The practical consequence is that the model predicts that fewer and fewer parts of speech can validly continue a sentence, the longer the sentence gets, until it eventually concludes that every candidate is ungrammatical.

The search method gets past this problem with a fourth transformation, Cheating, which resets the root of the tree to the highest node that can be successfully validated. The cost of Cheating is 1 multiplied by the number of parent nodes which get discarded, where 1 is the cost of a rule which only has a single attestation (in the original training data.)

### Rescoring

The search algorithm is used as a tool for rescoring candidate autosuggest words based on grammaticality. The problem of lexical ambiguity (e.g., “run” can be either a noun or a verb) is resolved as part of the rescoring process. As mentioned, the preliminary autosuggested words may be generated by a different process, such as by using a probabilistic language model.

Search States: The priority queue of sentence trees used by the search is wrapped in a class called a SearchState. Sentence trees have an extend function, which returns a vector of all the new, valid trees (if any) that can be generated by adding a particular grammar tag to the right-hand side of the tree. SearchStates, likewise, have an extend_search function, which pops the top tree off of the priority queue, calls extend on it, adds the returned trees to the queue, and repeats until the top tree on the queue has already been fully extended. This tree is then returned, and the cost of the SearchState is set to the cost of the tree.

The rescoring process described below involves making many copies of SearchStates.

Dealing with ambiguities: The general solution to this problem is to keep track of every possible interpretation of the words in a sentence and always return the least expensive interpretation. However, this demands some optimization—assuming two interpretations per word, a ten-word sentence already has over a thousand interpretations.

Aspects of the technology described herein solve this by creating another layer of the quasi-A* search described above, keeping a priority queue of SearchStates rather than sentence trees. Each SearchState represents one possible interpretation of the sentence, and the technology only extends a SearchState when it reaches the top of the queue. This way, we can track multiple possible interpretations, while still limiting the search to the examination of the most probable interpretations.

Returning costs: Once the top SearchState on the queue represents a complete interpretation of the sentence so far, it is possible for us to generate costs for the contrastive grammatical category of the next word. To do so, the technology clones the SearchState, and extends the clone's search, for each candidate contrastive grammatical category. (The cloned SearchStates can be cached, in order to add the appropriate SearchStates to the queue once the next word is known.) The extend_search function returns the best tree for a given contrastive grammatical category, including the cost of that tree. This is the cost associated with the next word having that particular tag. In this way, a cost can be determined for each candidate contrastive grammatical category.

Returning to FIG. 2, the composition component 216 is an application that allows the user to generate text. Exemplary composition components include text applications, email applications, word processing applications, spreadsheet applications, database applications, web browsers, contact management applications, games, and any other application that receives textual input from a user.

The reordering component 218 can take a plurality of autosuggest words proposed by the probabilistic language model and reorder them using cost data generated by the generative model component 214. In one aspect, as cost or probability generated for a word by the probabilistic model can be combined with a cost or probability generated by the contrastive grammatical model. In one aspect, the cost is expressed as a logarithmic probability, but other scales are possible. In one aspect the cost from both models is expressed on the same scale. If not expressed on the same scale, then a factor may be used to modify costs generated by one or both models prior to combination. Weighting may also be used to provide more weight to costs generated by one model.

As a simple conceptual example that gives both models equal weight, a first word (verb) may be assigned a cost of 2 by the probabilistic model and the grammar model may assign a cost of 50 to verbs. The combined score for the first word would be 52. A second word (noun) may be assigned a cost of 35 by the probabilistic model and the grammar model may assign a cost of 1 to nouns. The combined score for the second word would be 36. Assuming a low score is the best score, then the first and second words would be reordered with the second word moving ahead of the first word. The second word would be more likely to be presented through a user interface as an auto-complete suggestion.

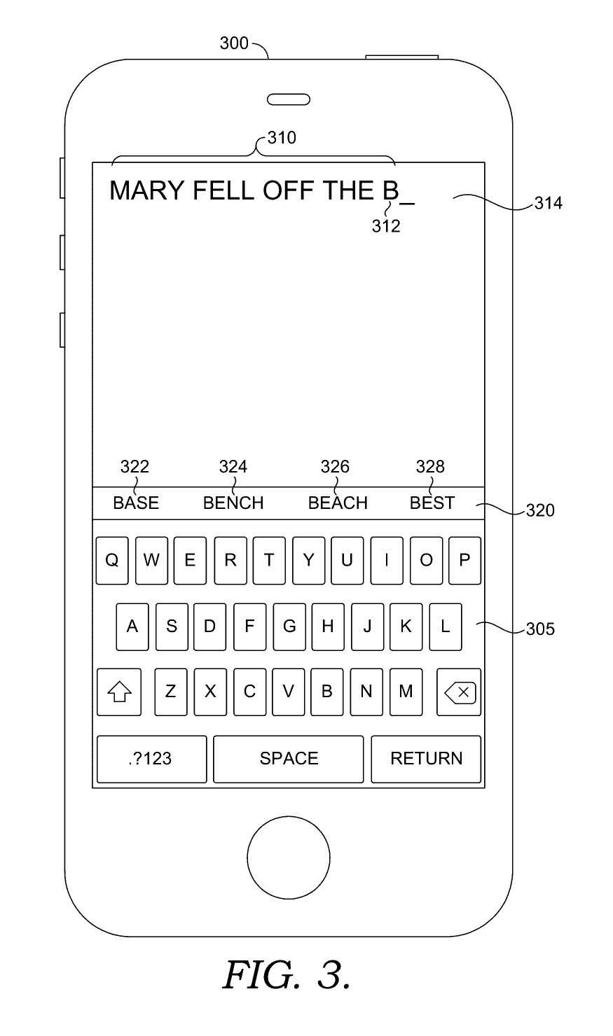

The autosuggest component 220 is an application that outputs one or more words to a user for selection. The user may select the one or more words instead of continuing to type a word or phrase. An autosuggest interface is illustrated with reference to FIG. 3. The autosuggest interface is programmed to receive a selection of an autosuggested word and communicate the word to the composition component.

The text input component 222 is an application that allows the user to generate text. For example, the text input component 222 could include one or more drivers that receive touchscreen input from a touchscreen keyboard and translate it into characters that can be communicated to a composition component. Aspects of the present technology are not limited for use with touchscreen keyboards. The text input component 222 could receive input from a dedicated keyboard, whether stand-alone or integrated with a device such as a laptop or smartphone.

Turning now to FIG. 3, an auto-complete interface 320 is illustrated. The auto-complete interface 320 is displayed above a touchscreen keyboard 305 on the touchscreen of smartphone 300. The auto-complete interface 320 displays four words that may be selected by a user touching the screen above the word. The displayed words include base 322, bench 324, beach 326, and best 328. Each of the displayed words could be the next word in the partial sentence “Mary fell off the.” In the example shown, the first character “B” in the next word has been entered by the user. Accordingly, all the words in the auto-complete interface 320 start with “B.” The words in the autosuggest include three nouns and an adjective. The presence of nouns and adjectives illustrates that words of more than one contrastive grammatical category may be included in the auto-complete words. In this case, the generative grammar model concluded that a noun is more likely to be used as an adjective, and nouns would have been favored when establishing an order of words to be presented.

### Training (i.e., Defining the Search Space)

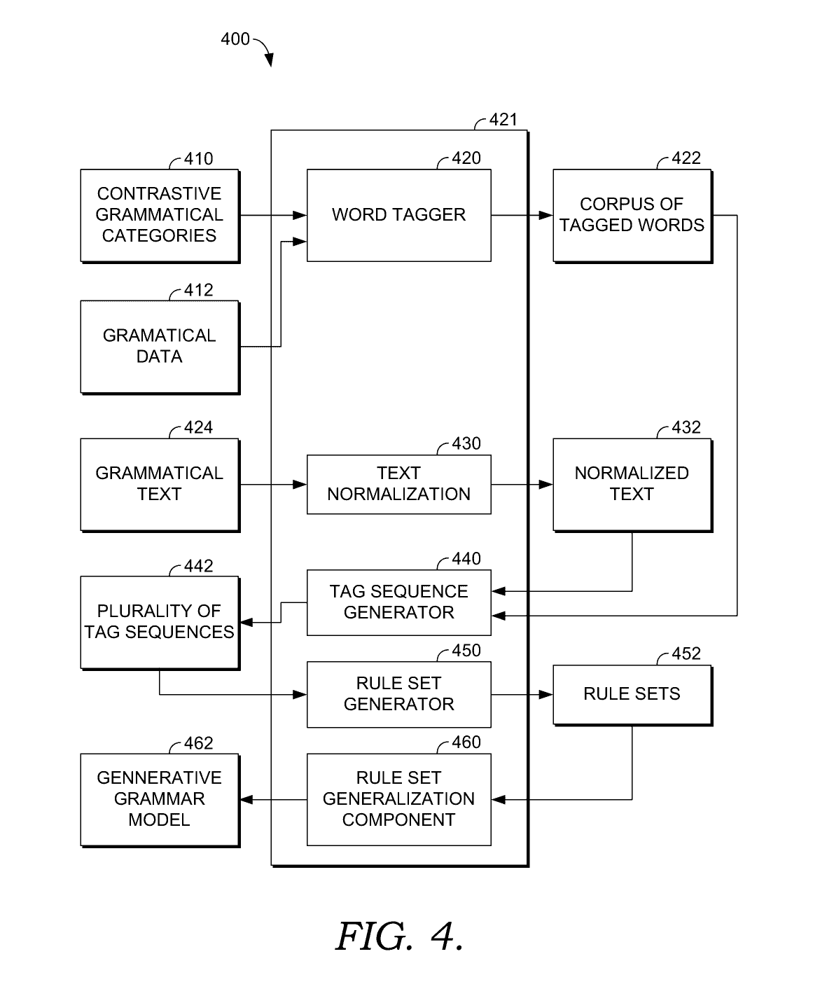

The first step is to build or train a generative language model. A corpus of grammatical text, such as novels, can be used to generate a language model comprising a set of PSRs and the associated costs. A training component 421 is illustrated in FIG. 4.

The training component 421 includes the word tagger 420, the text normalization component 430, the tag sequence generator 440, the rule set generator 450, and the rule set generalization component 460. The training component 421 may operate on a server that distributes a trained language model to user devices that can use it to generate autosuggestions.

The word tagger 420 receives a plurality of contrastive grammatical categories 410 and grammatical data 412. The word tagger 420 uses the contrastive grammatical categories 410 and grammatical data 412 to build a corpus of tagged words 422. Before the corpus of grammatical text can be analyzed, a set of structurally contrastive grammatical categories (“primitive tags”) needs to be selected. In one aspect, selecting grammatical categories is a manual process. For example, a list of language parts, such as nouns, verbs, adjectives, and adverbs, could be selected. Different languages can have different parts. The technology described herein can be used with English and other languages. In one aspect, less than all known language parts are included. The goal is to determine a reasonable set of structurally contrastive grammatical categories.

The contrastive grammatical categories correspond roughly to parts of speech. “Structurally contrastive” means that the condition for two words being in the same category is that any syntactically correct sentence containing the one word will remain syntactically correct (if not semantically sensible) if it is replaced with the other word. For example, “boy” and “dog” are in a grammatical category together, but “boy” and “boys” are not:

A boy chased a stick.

A dog chased a stick.

A boys chased a stick.

As can be seen, “boy” and “dog” are interchangeable, but “boys” results in a grammatically incorrect sentence.

Exemplary contrastive grammatical categories and example words in each are shown in FIG. 5. Table 500 lists contrastive grammatical categories in column 510 and provides example words from each category in column 530. Each language has its own set of contrastive grammatical categories. For example, the category first person pronoun 512 includes the pronoun I 532. A similar list could be generated for Spanish, French, Russian, Chinese, Japanese, Arabic, Italian, German, Korean, or such. In one aspect, different contrastive grammatical categories may be selected for different dialects of a language.

Once the contrastive grammatical categories are selected, words within the language need to be labeled into one or more contrastive grammatical categories. In some languages, such as English, multiple grammatical categories can be assigned to a single word. For example, “drink” can be a noun or a verb.

The grammatical data 412 includes a list of words within the language and associated contrastive grammatical categories. In one aspect, the grammatical data 412 is found in a spellcheck dictionary. In one aspect, words within the language are labeled by parsing a spellcheck dictionary. Spellcheck dictionaries are available for many different languages and can include grammatical categories for each word in the dictionary. Some types of spellcheck dictionaries can also be referred to as .tlx files. Aspects of the technology are not limited to use with spellcheck dictionaries. Once the parsing of the spellcheck dictionary is complete, a corpus of words is generated with each word associated with one or more primitive tags. Each primitive tag corresponds to a contrastive grammatical category.

In one aspect, the selection of contrastive grammatical categories to be used to train the language model is made in conjunction with the grammatical categories found in a spellcheck dictionary. In other words, it can be desirable to select contrastive grammatical categories that match grammatical categories within a spellcheck dictionary. Different spellcheck dictionaries may include different grammatical categories. Aspects of the technology described herein can parse multiple spellcheck dictionaries to generate primitive tags for words within a language. Accordingly, if no one spellcheck dictionary includes the grammatical categories desired to train the language model, then data can be extracted from multiple spellcheck dictionaries to generate a corpus of words tagged with the desired contrastive grammatical categories.

The text normalization component 430 can normalize a corpus of grammatical text 424 to generate normalized text 432. Examples of grammatical text include novels and newspaper articles. Other sources of grammatical text are possible. Dialogue from novels provides high-quality training data, in terms of matching up with real-world usage. The normalization process splits the grammatical text into sentences or phrases. The sentences will be analyzed in subsequent steps to generate PSRs. The training process described herein can use complete sentences, or at least complete phrases, as input. The normalization process identifies “sentence breakers” to delineate one sentence or phrase from another. During the normalization process, text between two sentence breakers can be identified as a sentence or phrase. Exemplary sentence breakers include quotation marks, periods, colons, and semicolons. Sentence breakers may vary from language to language. For the sake of training, the commas, dashes, and parentheses can be treated as commas and given the primitive tag PAREN indicating that they begin or terminate parenthetical statements.

The tag sequence generator 440 uses the normalized text 432 and a corpus of tagged words 422 to generate a plurality of tag sequences 442. A sequence of primitive tags is generated by replacing words in a sentence with a primitive tag assigned to the word. For example, the sentence “Mary fell off the bench” could be replaced with N, V, P, D, N as described above. As described previously, each primitive tag corresponds to a contrastive grammatical category. The process of replacing a word with a primitive tag is straightforward when the word is only associated with a single primitive tag. However, many words could correspond to any of a number of tags, depending on context. For example, the word “run” could have the tag NOUN_SING (I went for a run), VERB_DEFAULT (I like to run), VERB_PAST_PART (he had run a marathon), or ADJ (it's a done deal, a run race). Identifying the correct tag for each word is a difficult problem, especially in languages with high degrees of ambiguity like English. Aspects of the technology described herein solve this problem by generating statistics on likely tag sequences weighted inversely to the ambiguity of the data, and repeating over several iterations as the confidence for each tag choice improves. In one aspect, the probabilities are calculated using a sequence of three or more consecutive tags.

An additional method of selecting the correct primitive tag is to bootstrap the grammar model using the probability calculation method describe above to generate a preliminary choice, and then apply the grammar model itself to the disambiguation problem (as described previously, it does this sort of disambiguation in real time). The model could then be retrained using the improved tag sequences in the preliminary choice replaced with an improved choice, when applicable.

The rule set generator 450 receives a plurality of grammatical sequences 442 as input and generates a set of rule sets 452. Once a sequence of primitive tags are generated by replacing words within delineated sentences with primitive tags, the tag sequences are collapsed based on constituency to generate a flat rule set. In an aspect, each sentence in the purpose of training data can be collapsed by calculating the significance (also described as constituency strength) of each pair of tags, merging every instance of the most significant pair into a new non-primitive tag, and repeating into every sentence is a single tag. The significance of a tag sequence is the probability of the sequence AB divided by the product of the individual probabilities of A and B. In equation form, the significance of the tag can be expressed as:

$$\frac{P ( B \vert A )}{P ( A ) P ( B )}$$

As mentioned, the technology described herein builds a series of rule sets. A rule set is a list of rules, each of which has the following properties (plus, potentially, some other information to help with indexing): a name (i.e., a non-primitive tag), the names of the tags on the left & right branches after the rule is expanded, and a probability or cost. By treating constituency as a sliding scale, a sentence can be turned into a binary tree by iteratively partitioning it into the sub-phrases that exhibit the strongest constituency.

It is possible for multiple rules to have the same name. This indicates that a non-primitive tag can be expanded in more than one way. For example, the non-primitive tag V′ (representing a verb phrase) could be expanded either as “jumped off” or “jumped off gracefully,” etc. The verb phrase could be expanded to include only the prepositional phrase V′→V PP or to also include the adverb “gracefully,” which is expressed: V′→V′ Adv. Note how rules can also be recursive.

“Robustness” refers to the capability of a rule set to generate the set of all grammatical sentences, not only sentences with the same structure as those in the training data. If the model is built by simply generating a rule set by collapsing the sentences in the training data, as described above, there is no robustness—each S tag can only be expanded in one way, therefore the model cannot generate any sentence structures other than those in the training data.

The rule set generalization component 460 receives the rule sets 452 as input and generalizes them to produce the generative grammar model 462, which comprises phrase rule sets and associated costs. In order to produce a robust rule set, the present technology generalizes the rules derived directly from the training data. The original rules can be generalized by identifying sets of structurally equivalent rules using clustering. If two non-primitive tags are structurally equivalent (that is, they are together in a structurally contrastive category, as discussed when selecting the primitive tags used to build the model), then the two non-primitive tags can be treated as a single tag.

For example, if tag A represents phrases like “a dog runs,” and tag B represents phrases like “some dogs run,” the present technology creates a new tag C representing both cases, and replaces every instance of A and B in the initial rule set with C.

Structurally equivalent tags can be identified using a similarity function and hierarchical clustering. In one aspect, the following similarity function is used:

$$s ( x , y ) = \frac{1}{{Σ}_{c} ( {x}_{c} + {y}_{c} )} {Σ}_{c} ( ( {x}_{c} + {y}_{c} ) \frac{2 {rx}_{c} {y}_{c}}{{r}^{2} {x}_{c}^{2} + {y}_{c}^{2}} ) where r = \frac{{Σ}_{c} {Y}_{c}}{{Σ}_{c} {X}_{c}}$$

The similarity of the two tags x and y is the average, over which each context in which x and y might occur weighted by how much data is available for x and y in the context. The notation x_{c} denotes the count of tag x in context c and r is the ratio of the frequency of y to the frequency of x across all contexts. The function scores on a scale from 0 to 1, how closely the ratio of x and y in a given context matches the expected ratio. If this function gives 1 in all contexts, x and y may differ in frequency, but they are distributed identically in the language and therefore structurally interchangeable. Σ_{c}y_{c} represents the sum of the counts of tag y across all contexts.

Hierarchical clustering. Hierarchical clustering can be used to identify clusters in a set of points with a distance function which doesn't make geometrical sense (i.e., doesn't satisfy the triangle inequality). In each iteration the two closest points are merged, and then distances are recalculated. Using the similarity function as the (inverse) distance function, the distance between a point and a cluster can be calculated using “complete-linkage clustering,” in which the distance to a cluster is the distance to the furthest point in a cluster. This avoids accidental overgeneralization (merging rules which are not structurally equivalent).

The final step in the generalization process can be generating a new rule set in which the similar clusters have been “merged” into non-primitive tags. Merging rules can cause other rules to become redundant. For example, given rule C→A E and rule D→B E, suppose A and B are merged into a new tag Z to generate rules C→Z E and D→Z E, so merging A and B now forces us to merge C and D as well because they both equal Z E.

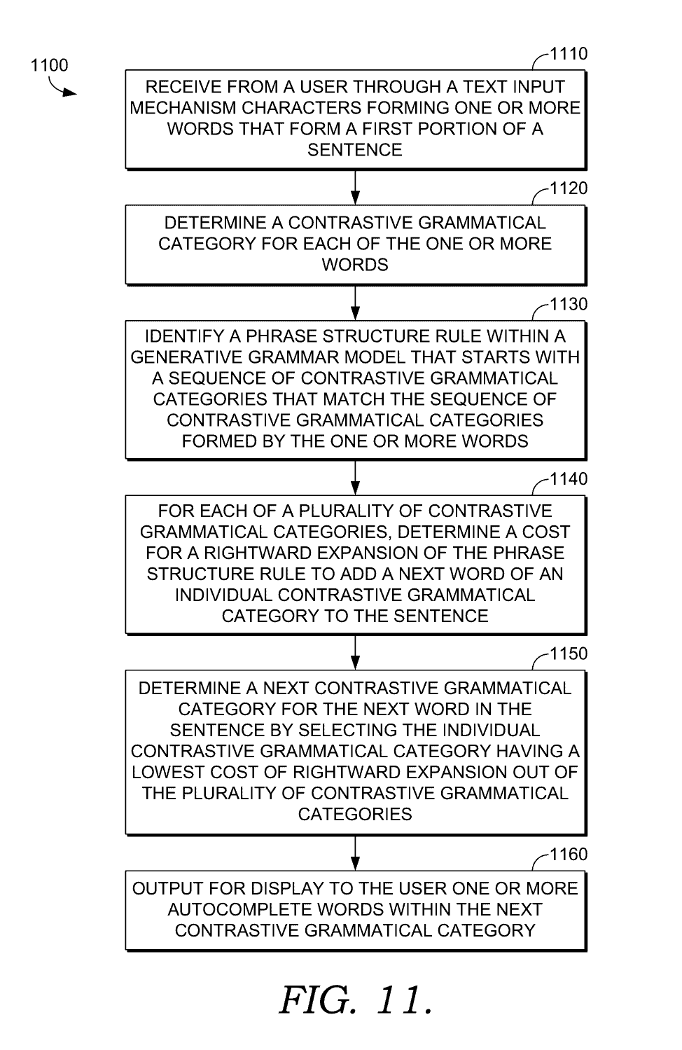

Turning now to FIG. 11, a method 1100 that generates an auto-complete word is shown. At step 1110, characters forming one or more words that form a first portion of a sentence are received from a user through a text input mechanism. For example, the characters may be typed on a touchscreen keyboard by a user operating a smartphone or tablet. Other text input mechanisms are possible.

At step 1120, a contrastive grammatical category for each of the one or more words in the first portion of the sentence is determined. The contrastive grammatical category for each word may be determined using grammatical data that associates various words with one or more grammatical categories.

At step 1130, a phrase structure rule within a generative grammar model that starts with a sequence of contrastive grammatical categories that match the sequence of contrastive grammatical categories formed by the one or more words is identified. In one aspect, if a phrase structure rule is not able to match the sequence of contrastive grammatical categories, then the first portion of the sentence is determined to be not grammatical and no further actions are taken.

In another aspect, a bottom-up, depth-first approach is used to generate suitable contrastive grammatical categories and associated costs. The bottom-up, depth-first approach assumes that the partial sentence input forms a valid tree structure. The bottom-up, depth-first approach evaluates different ways to add a new word to the right-hand side of the valid tree structure and still produce another valid tree. In one aspect, each available contrastive grammatical category is tested to determine whether a valid tree structure can be produced and the associated cost of producing a valid tree structure.

The tree can be built up incrementally, word-by-word, or by choosing the least expensive tree candidate each time a word is added (i.e., a greedy approach). In one aspect, the greedy approach can be implemented as a modified A* search, with the cost function: cost=original cost×greediness^{-depth}. Following a path which causes the cost to increase by a factor of more than greediness forces the previous choice of paths to be reconsidered. The above violates the monotonically non-decreasing condition of the cost function, so the search is no longer guaranteed to find the lowest cost path. Adjusting greediness of 1.0 is identical to A*; greediness of ∞ is a true depth-first search.

At step 1140, for each of a plurality of contrastive grammatical categories, a cost for a rightward expansion of the phrase structure to add a next word of an individual contrastive grammatical category to the sentence is determined.

At step 1150, a next contrastive grammatical category for the next word in the sentence is determined by selecting the individual contrastive grammatical category having a lowest cost of rightward expansion out of the plurality of contrastive grammatical categories. The priority queue of sentence trees used by the search is wrapped in a class called a SearchState. Sentence trees have an extend function, which returns a vector of all the new, valid trees (if any) that can be generated by adding a particular grammar tag to the right-hand side of the tree. SearchStates, likewise, have an extend_search function, which pops the top tree off of the priority queue, calls extend on it, adds the returned trees to the queue, and repeats until the top tree on the queue has already been fully extended. This tree is then returned, and the cost of the SearchState is set to the cost of the tree.

The rescoring process described below involves making many copies of SearchStates. The general solution to this problem is to keep track of every possible interpretation of the words in a sentence and always return the least expensive interpretation. However, this demands some optimization—assuming two interpretations per word, a ten-word sentence already has over a thousand interpretations.

Aspects of the technology described herein solve this by creating another layer of the quasi-A* search described above, keeping a priority queue of SearchStates rather than sentence trees. Each SearchState represents one possible interpretation of the sentence, and the technology only extends a SearchState when it reaches the top of the queue. This way, we can track multiple possible interpretations, while still limiting the search to the examination of the most probable interpretations.

Once the top SearchState on the queue represents a complete interpretation of the sentence so far, it is possible for us to generate costs for the contrastive grammatical category of the next word. To do so, the technology clones the SearchState, and extends the clone's search, for each candidate contrastive grammatical category. (The cloned SearchStates can be cached, in order to add the appropriate SearchStates to the queue once the next word is known.) The extend_search function returns the best tree for a given contrastive grammatical category, including the cost of that tree. This is the cost associated with the next word having that particular tag. In this way, a cost can be determined for each candidate contrastive grammatical category.

At step 1160, one or more auto-complete words within the next contrastive grammatical category are output for display to the user. The auto-complete words may be output through an interface, such as interface 320, described previously. The auto-complete interface can include limited space. Accordingly, words with the highest likelihood of being used in the sentence are included. The likelihood may be determined by adjusting a rank initially assigned to an auto-complete word by a probabilistic language model using data from the generative grammar model.

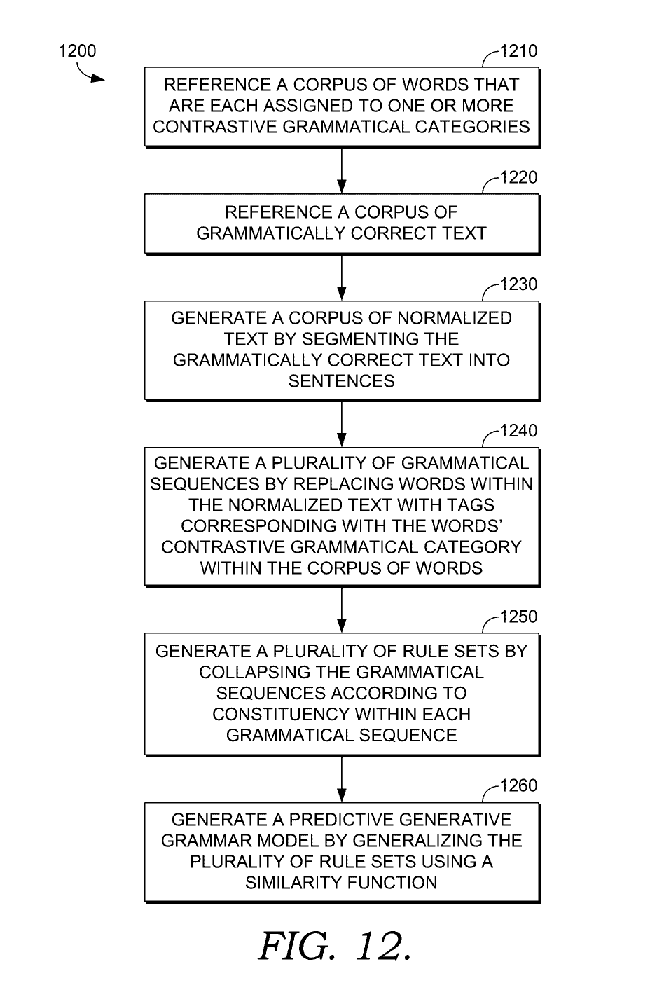

Turning now to FIG. 12, a method 1200 of suggesting a grammatically correct auto-complete word to a user is shown. At step 1210, a corpus of words that are each assigned to one or more contrastive grammatical categories is referenced. Before the corpus of grammatical text can be analyzed, a set of structurally contrastive grammatical categories (“primitive tags”) is selected. In one aspect, selecting grammatical categories is a manual process. For example, a list of language parts, such as nouns, verbs, adjectives, and adverbs, could be selected. Different languages can have different parts. The technology described herein can be used with English and other languages. In one aspect, less than all known language parts are included. The goal is to determine a reasonable set of structurally contrastive grammatical categories.

The contrastive grammatical categories correspond roughly to parts of speech. “Structurally contrastive” means that the condition for two words being in the same category is that any syntactically correct sentence containing the one word will remain syntactically correct (if not semantically sensible) if it is replaced with the other word. For example, “boy” and “dog” are in a grammatical category together, but “boy” and “boys” are not:

A boy chased a stick.

A dog chased a stick.

A boys chased a stick.

As can be seen, “boy” and “dog” are interchangeable, but “boys” results in a grammatically incorrect sentence. Exemplary contrastive grammatical categories and example words in each are shown in FIG. 5.

Once the contrastive grammatical categories are selected, words within the language need to be labeled into one or more contrastive grammatical categories. In some languages, such as English, multiple grammatical categories can be assigned to a single word. For example, “drink” can be a noun or a verb. In one aspect, words within the language are labeled by parsing a spellcheck dictionary. Spellcheck dictionaries are available for many different languages and can include grammatical categories for each word in the dictionary. Some spellcheck dictionaries can also be referred to as .tlx files. Aspects of the technology are not limited to use with spellcheck dictionaries. Once the parsing of the spellcheck dictionary is complete, a corpus of words is generated with each word associated with one or more primitive tags. Each primitive tag corresponds to a contrastive grammatical category.

In one aspect, the selection of contrastive grammatical categories to be used to train the language model is made in conjunction with the grammatical categories found in a spellcheck dictionary. In other words, it can be desirable to select contrastive grammatical categories that match grammatical categories within a spellcheck dictionary. Different spellcheck dictionaries may include different grammatical categories. Aspects of the technology described herein can parse multiple spellcheck dictionaries to generate primitive tags for words within a language. Accordingly, if no single spellcheck dictionary includes the grammatical categories desired to train the language model, then data can be extracted from multiple spellcheck dictionaries to generate a corpus of words tagged with the desired contrastive grammatical categories.

At step 1220, a corpus of grammatically correct text is referenced. Examples of grammatical text include novels and newspaper articles. Other sources of grammatical text are possible. Dialogue from novels provides high-quality training data, in terms of matching up with real-world usage.

At step 1230, a corpus of normalized text is generated by segmenting the grammatically correct text into sentences. The normalization process splits the grammatical text into sentences or phrases. The sentences will be analyzed in subsequent steps to generate PSRs. The training process described herein can use complete sentences, or at least complete phrases, as input. The normalization process identifies “sentence breakers” to delineate one sentence or phrase from another. During the normalization process, text between two sentence breakers can be identified as a sentence or phrase. Exemplary sentence breakers include quotation marks, periods, colons, and semicolons. Sentence breakers may vary from language to language. For the sake of training, the commas, dashes, and parentheses can be treated as commas and given the primitive tag PAREN indicating that they begin or terminate parenthetical statements.

At step 1240, a plurality of grammatical sequences is generated by replacing words within the normalized text with tags corresponding with the words' contrastive grammatical category within the corpus of words. For example, the sentence “Mary fell off the bench” could be replaced with N, V, P, D, N as described above. As described previously, each primitive tag corresponds to a contrastive grammatical category. The process of replacing a word with a primitive tag is straightforward when the word is only associated with a single primitive tag. However, many words could correspond to any of a number of tags, depending on context. For example, the word “run” could have the tag NOUN_SING (I went for a run), VERB_DEFAULT (I like to run), VERB_PAST_PART (he had run a marathon), or ADJ (it's a done deal, a run race). Identifying the correct tag for each word is a difficult problem, especially in languages with high degrees of ambiguity like English. Aspects of the technology described herein solve this problem by generating statistics on likely tag sequences weighted inversely to the ambiguity of the data, and repeating over several iterations as the confidence for each tag choice improves. In one aspect, the probabilities are calculated using a sequence of three or more consecutive tags.

An additional method of selecting the correct primitive tag is to bootstrap the grammar model using the probability calculation method described above to generate a preliminary choice, and then apply the grammar model itself to the disambiguation problem (as will be described later, it does this sort of disambiguation in real time). The model could then be retrained using the improved tag sequences in the preliminary choice replaced with a improved choice, when applicable.

At step 1250, a plurality of rule sets are generated by collapsing the grammatical sequences according to constituency within each grammatical sequence. The tag sequences are collapsed based on constituency to generate a flat rule set. In an aspect, each sentence in the purpose of training data can be collapsed into a single rule set by calculating the significance of each pair of tags within the sentence, merging every instance of the most significant pair into a new non-primitive tag, and repeating until every sentence is a single tag. The collapsed sentences can be ten words, twenty words, or more. The significance of a tag sequence is the probability of the sequence AB divided by the product of the individual probabilities of A and B. In equation form, the significance of the tag can be expressed as:

$$\frac{P ( B \vert A )}{P ( A ) P ( B )}$$

As mentioned, the technology described herein builds a series of rule sets. A rule set is a list of rules, each of which has the following properties (plus, potentially, some other information to help with indexing): a name (i.e., a non-primitive tag), the names of the tags on the left & right branches after the rule is expanded, and a probability or cost.

It is possible for multiple rules to have the same name. This indicates that a non-primitive tag can be expanded in more than one way. For the example, the non-primitive tag V′ (representing a verb phrase) could be expanded either as “jumped off” or “jumped off gracefully,” etc. The verb phrase could be expanded to include only the prepositional phrase V′→V PP or to also include the adverb “gracefully,” which is expressed: V′→V′ Adv. Note how rules can also be recursive.

“Robustness” refers to the capability of a rule set to generate the set of all grammatical sentences, not only sentences with the same structure as those in the training data. If the model is built by simply generating a rule set by collapsing the sentences in the training data, as described above, there is no robustness—each S tag can only be expanded in one way, therefore the model cannot generate any sentence structures other than those in the training data.

At step 1260, a predictive generative grammar model is generated by generalizing the plurality of rule sets using a similarity function. In order to produce a robust rule set, the present technology generalizes the rules derived directly from the training data. The original rules can be generalized by identifying sets of structurally equivalent rules using clustering. If two non-primitive tags are structurally equivalent (that is, they are together in a structurally contrastive category, as discussed when selecting the primitive tags used to build the model), then the two non-primitive tags can be treated as a single tag.

For example, if tag A represents phrases like “a dog runs,” and tag B represents phrases like “some dogs run,” the present technology creates a new tag C representing both cases, and replaces every instance of A and B in the initial rule set with C.

Structurally equivalent tags can be identified using a similarity function and hierarchical clustering. In one aspect, the following similarity function is used:

$$s ( x , y ) = \frac{1}{{Σ}_{c} ( {x}_{c} + {y}_{c} )} {Σ}_{c} ( ( {x}_{c} + {y}_{c} ) \frac{2 {rx}_{c} {y}_{c}}{{r}^{2} {x}_{c}^{2} + {y}_{c}^{2}} ) where r = \frac{{Σ}_{c} {Y}_{c}}{{Σ}_{c} {X}_{c}}$$

The similarity of the two tags x and y is the average, over which each context in which x and y might occur weighted by how much data is available for x and y in the context. The notation x_{c} denotes the count of tag x in context c and r is the ratio of the frequency of y to the frequency of x across all contexts. The function scores on a scale from 0 to 1, how closely the ratio of x and y in a given context matches the expected ratio. If this function gives 1 in all contexts, x and y may differ in frequency, but they are distributed identically in the language and therefore structurally interchangeable. Σ_{c}y_{c} represents the sum of the counts of tag y across all contexts.

Hierarchical clustering. Hierarchical clustering can be used to identify clusters in a set of points with a distance function which doesn't make geometrical sense (i.e., doesn't satisfy the triangle inequality). In each iteration, the two closest points are merged, and then distances are recalculated. Using the similarity function as the (inverse) distance function, the distance between a point and a cluster can be calculated using “complete-linkage clustering,” in which the distance to a cluster is the distance to the furthest point in a cluster. This avoids accidental overgeneralization (merging rules which are not structurally equivalent).

The final step in the generalization process can be generating a new rule set in which the similar clusters have been “merged” into non-primitive tags. Merging rules can cause other rules to become redundant. For example, given rule C→A E and rule D→B E, suppose A and B are merged into a new tag Z to generate rules C→Z E and D→Z E, so merging A and B now forces us to merge C and D as well because they both equal Z E.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

### Embodiment 1

A method that generates an auto-complete word, the method comprising: receiving from a user through a text input mechanism characters forming one or more words that form a first portion of a sentence; determining a contrastive grammatical category for each of the one or more words; identifying a phrase structure rule within a generative grammar model that starts with a sequence of contrastive grammatical categories that match the sequence of contrastive grammatical categories formed by the one or more words; for each of a plurality of contrastive grammatical categories, determining a cost for a rightward expansion of the phrase structure rule to add a next word of an individual contrastive grammatical category to the sentence; determining a next contrastive grammatical category for the next word in the sentence by selecting the individual contrastive grammatical category having a lowest cost of rightward expansion out of the plurality of contrastive grammatical categories; and outputting for display to the user one or more auto-complete words within the next contrastive grammatical category.

### Embodiment 2

The method of embodiment 1, wherein the method further comprises receiving a textual input comprising one or more characters that form less than all of the next word in the sentence, and wherein the one or more auto-complete words begin with the one or more characters.

### Embodiment 3

The method of any of the above embodiments, wherein the one or more auto-complete words are received from a probabilistic language model, wherein the probabilistic language model assigns a probability that the next word is grammatically correct and the generative grammar model makes a binary decision whether a word is grammatically correct.

### Embodiment 4

The method of any of the above embodiments, wherein the cost of rightward expansion is determined using an A* algorithm.

### Embodiment 5

The method of any of the above embodiments, wherein cost=original cost×greediness^{-depth}.

### Embodiment 6

The method of embodiment 5, wherein greediness is between 1 and 5.

### Embodiment 7

The method of any of the above embodiments, wherein the one or more words is four words.

### Embodiment 8

A computing system comprising: a processor; computer storage memory; a touchscreen display; a composition application programmed to receive textual input from a user typing on a touchscreen keyboard displayed on the touchscreen display, the textual input comprising a first word in a sentence; a probabilistic language model component programmed to generate a plurality of possible next words in the sentence, each word ranked according to a probability assigned by the probabilistic language model; a generative grammar model component that is programmed to determine a contrastive grammatical category for the next word in the sentence having a lowest cost to complete a grammatical sentence; a reordering component that is programmed to assign a new rank to the possible next words using the contrastive grammatical category and the rank assigned by the probabilistic language model; and an auto-complete interface component that is programmed to output for display through the touchscreen display, a subset of the plurality of the possible next words in the sentence, the subset displayed in an auto-complete graphical user interface, the subset comprising words assigned above a threshold new rank.

### Embodiment 9

The system of embodiment 8, wherein the auto-complete interface component is programmed to receive a selection of one of the subset of possible words and communicate the selection to the composition component.

### Embodiment 10

The system of any of embodiments 8 or 9, wherein the lowest cost to complete a grammatical sentence is determined using a top-down approach.

### Embodiment 11

The system of any of embodiments 8-10, wherein the lowest cost to complete a grammatical sentence is determined using a bottom-up approach.

### Embodiment 12

The system of any of embodiments 8-11, wherein the contrastive grammatical category associated with the next word is one of several contrastive grammatical categories that could form the grammatical sentence.

### Embodiment 13

The system of embodiment 12, wherein the reordering component eliminates possible next words that are not within one of several contrastive grammatical categories that could form the grammatical sentence.

### Embodiment 14

The system of any of embodiments 8-13, wherein the reordering component reduces a rank of individual possible next words that are within one of several contrastive grammatical categories that could form the grammatical sentence that have above a threshold cost.

### Embodiment 15

The system of any of embodiments 8-14, wherein said cost=original cost×greediness^{-depth}.

### Embodiment 16

A method of suggesting a grammatically correct auto-complete word to a user, the method comprising: referencing a corpus of words that are each assigned to one or more contrastive grammatical categories; referencing a corpus of grammatically correct text; generating a corpus of normalized text by segmenting the grammatically correct text into sentences; generating a plurality of grammatical sequences by replacing words within the corpus of normalized text with tags corresponding with the words' contrastive grammatical category within the corpus of words; generating a plurality of rule sets by collapsing the grammatical sequences according to constituency within each grammatical sequence; and generating a predictive generative grammar model by generalizing the plurality of rule sets using a similarity function.

### Embodiment 17

The method of embodiment 16, wherein a pair of tags with the highest significance is collapsed first when generating the plurality of rule sets.

### Embodiment 18

The method of any of embodiment 16 or 17, wherein significance of a tag sequence is the probability of the sequence AB divided by the product of the individual probabilities of A and B, where A and B are contrastive grammatical categories, and the probabilities are based on rate of occurrence within the corpus of grammatically correct text.

### Embodiment 19

The method of any of embodiment 16-18, wherein the corpus of grammatically correct text is generated using one or more novels.

### Embodiment 20

The method of any of embodiment 16-19, wherein a single rule is generated by collapsing a sentence comprising more than ten words in into the single rule.

Aspects of the invention have been described to be illustrative rather than restrictive. It will be understood that certain features and subcombinations are of utility and may be employed without reference to other features and subcombinations. This is contemplated by and is within the scope of the claims.

The invention claimed is:

1. A method that generates an auto-complete word, the method comprising:
receiving from a user through a text input mechanism characters forming one or more words that form a first portion of a sentence;
determining a contrastive grammatical category for each of the one or more words;
identifying a phrase structure rule within a generative grammar model that starts with a sequence of contrastive grammatical categories that match the sequence of contrastive grammatical categories formed by the one or more words;
for each of a plurality of contrastive grammatical categories, determining a cost for a rightward expansion of the phrase structure rule to add a next word of an individual contrastive grammatical category to the sentence;
determining a next contrastive grammatical category for the next word in the sentence by selecting the individual contrastive grammatical category having a lowest cost of rightward expansion out of the plurality of contrastive grammatical categories; and
outputting for display to the user one or more auto-complete words within the next contrastive grammatical category.

2. The method of claim 1, wherein the method further comprises receiving a textual input comprising one or more characters that form less than all of the next word in the sentence, and wherein the one or more auto-complete words begin with the one or more characters.

3. The method of claim 1, wherein the one or more auto-complete words are received from a probabilistic language model, wherein the probabilistic language model assigns a probability that the next word is grammatically correct and the generative grammar model makes a binary decision whether a word is grammatically correct.

4. The method of claim 1, wherein the cost of rightward expansion is determined using an A* algorithm.

5. The method of claim 1, wherein cost=original cost×greediness^{-depth}.

6. The method of claim 5, wherein greediness is between 1 and 5.

7. The method of claim 1, wherein the one or more words is four words.

8. A computing system comprising:
a processor;
computer storage memory;
a touchscreen display;
a composition application programmed to receive textual input from a user typing on a touchscreen keyboard displayed on the touchscreen display, the textual input comprising a first word in a sentence;
a probabilistic language model component programmed to generate a plurality of possible next words in the sentence, each word ranked according to a probability assigned by the probabilistic language model;
a generative grammar model component that is programmed to determine a contrastive grammatical category for the next word in the sentence having a lowest cost to complete a grammatical sentence;
a reordering component that is programmed to assign a new rank to the possible next words using the contrastive grammatical category and the rank assigned by the probabilistic language model; and
an auto-complete interface component that is programmed to output for display through the touchscreen display, a subset of the plurality of the possible next words in the sentence, the subset displayed in an auto-complete graphical user interface, the subset comprising words assigned above a threshold new rank.

9. The system of claim 8, wherein the auto-complete interface component is programmed to receive a selection of one of the subset of possible words and communicate the selection to the composition component.

10. The system of claim 8, wherein the lowest cost to complete a grammatical sentence is determined using a top-down approach.

11. The system of claim 8, wherein the lowest cost to complete a grammatical sentence is determined using a bottom-up approach.

12. The system of claim 8, wherein the contrastive grammatical category associated with the next word is one of several contrastive grammatical categories that could form the grammatical sentence.

13. The system of claim 12, wherein the reordering component eliminates possible next words that are not within one of several contrastive grammatical categories that could form the grammatical sentence.

14. The system of claim 8, wherein the reordering component reduces a rank of individual possible next words that are within one of several contrastive grammatical categories that could form the grammatical sentence that have above a threshold cost.

15. The system of claim 14, wherein said cost=original cost×greediness^{-depth}.

16. A method of suggesting a grammatically correct auto-complete word to a user, the method comprising:
referencing a corpus of words that are each assigned to one or more contrastive grammatical categories;
referencing a corpus of grammatically correct text;
generating a corpus of normalized text by segmenting the grammatically correct text into sentences;
generating a plurality of grammatical sequences by replacing words within the corpus of normalized text with tags corresponding with the words' contrastive grammatical category within the corpus of words;
generating a plurality of rule sets by collapsing the grammatical sequences according to constituency within each grammatical sequence; and
generating a predictive generative grammar model by generalizing the plurality of rule sets using a similarity function.

17. The method of claim 16, wherein a pair of tags with the highest significance is collapsed first when generating the plurality of rule sets.

18. The method of claim 16, wherein significance of a tag sequence is the probability of the sequence AB divided by the product of the individual probabilities of A and B, where A and B are contrastive grammatical categories, and the probabilities are based on rate of occurrence within the corpus of grammatically correct text.

19. The method of claim 16, wherein the corpus of grammatically correct text is generated using one or more novels.

20. The method of claim 16, wherein a single rule is generated by collapsing a sentence comprising more than ten words in into the single rule.
